(19) United States
(12) Patent Application Publication
(10) Pub. No.: US 2005/0201728 A1
(43) Pub. Date: Sep. 15, 2005

(54) Writing/reading system of HD stream

(75) Inventors: Hyun Sang Park, Seoul (KR); Woo Hyun Paik, Yongin-si (KR); Jong Seok Park, Goonpo-si (KR); Kang Suk Chai, Seoul (KR); Ssang Soo Lee, Suwon-si (KR); Jong Won Lim, Anyang-si (KR); Hyung Jin Kim, Seoul (KR); Bo Sung Kim, Incheon-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/076,865

(22) Filed: Mar. 11, 2005

(30) Foreign Application Priority Data
Mar. 12, 2004 (KR) 16808/2004

(51) Int. Cl. H04N 5/76; H04N 5/781

(52) U.S. Cl. 386/94; 386/123; 386/125

(57) ABSTRACT

The present invention provides an writing/reading system of HD stream in a digital broadcast product, by which HD transport stream is wrote/read in/from a disc medium. The present invention buffers the HD transport stream in HDD to record in a DVD-RW medium. And, the present invention reads the transport stream recorded in the DVD medium via a decoder, thereby storing the HD transport stream in the DVD medium.

### BACKGROUND OF THE INVENTION

1. Field of the Invention

The present invention relates to a disc writing/reading system, and more particularly, to a writing/reading system of HD stream, by which HD streams can be wrote/read in/from a DVD recorder having a hard disc inside.

2. Discussion of the Related Art

Generally, a digital broadcast receiver includes a hard disc drive (HDD) as a storage medium for storing received data streams therein, which is implemented in a following manner as shown in FIG. 1.

FIG. 1 is a block diagram of a digital broadcast receiver according to a related art.

Referring to FIG. 1, a digital broadcast receiver consists of a tuner/demodulator 2 receiving a broadcast signal from a prescribed service medium to output digital data, a stream controller 4 adjusting a transport path of a data stream from the tuner/demodulator 2, a DEMUX/MPEG (demultiplexer/Moving Pictures Experts Group) decoder 6 connected to an output end of the stream controller 4, an MPEG memory 8 connected to the DEMUX/MPEG decoder 6, RAM/CPU/ROM/user interface 12/14/16/18 connected to a system bus 10 in common, and a hard disc drive (HDD) 20 storing the data stream therein.

An operation of the digital broadcast receiver is explained as follows.

First of all, the tuner/demodulator 2 receives a broadcast signal transmitted from a service medium via an input line 1 and then converts the received broadcast signal to a digital data stream to output.

By a control of the CPU 14, the stream controller 4 stores the data stream outputted from the tuner/demodulator 2 in the HDD 20 or outputs the data stream to the DEMUX/MPEG decoder 6 for reading. And, the stream controller 4 reads the data stream stored in the HDD 20 via the DEMUX/MPEG decoder 6.

By a control of the CPU 14, the DEMUX/MPEG decoder 6 selects the data stream inputted from the stream controller 4, temporarily stores the selected data stream in the MPEG memory 8, reads the stored data stream to decode by MPEG, and then outputs the decoded data stream via an output line 7.

The CPU 14 controls communications of the respective units via the system bus 10 and performs a control operation corresponding to a user command inputted from the user interface 18. For instance, the CPU 14 changes a receiving channel of the tuner/demodulator 2 according to a user command and changes a receiving path of the data stream in the stream controller 4.

And, the RAM (random access memory) 12 and the ROM (read only memory) 16 are used in the control operation of the CPU 14.

Thus, the related art digital broadcast receiver stores the received data stream to read or reads and stores the received data stream simultaneously, using the HDD 20. In this case, even if the received data stream generally includes several broadcast programs, a user does not view the several broadcast programs simultaneously but selects to view a specific broadcast program only.

Various digital product groups are developed and marketed as digital broadcasting has lately been put to practical use. And, products equipped with PVR (personal video recorder) function come into the market.

Since a conventional DVD-RW (digital versatile disc-rewritable) stores broadcast streams by PS (program streaming) format or stores analog outputs of decoded HD streams, it is impossible to store/read HD real-time broadcast streams without degradation of image quality.

Namely, the related art DVD, which can store the video streams, is DVD-Video or DVD-VR (video recorder) that can store SD (standard definition) streams only. In this case, the related art DVD has a capacity of about two-hour storage of DVD image quality.

However, in the related art DVD, the DVD medium can store not the currently broadcasted HD video streams but the SD video streams. Hence, the demand for storing HD video streams in DVD perpetually despite the reduction of reading time is rising.

### SUMMARY OF THE INVENTION

Accordingly, the present invention is directed to a writing/reading system of HD stream that substantially obviates one or more problems due to limitations and disadvantages of the related art.

A first object of the present invention is to provide a writing/reading system of HD stream, by which a DVD recorder having a hard disc inside is provided.

A second object of the present invention is to provide a writing/reading system of HD stream, by which HD streams can be stored in a DVD record medium.

A third object of the present invention is to provide a writing/reading system of HD stream, by which HD streams stored in a DVD record medium can be read.

A fourth object of the present invention is to provide a writing/reading system of HD stream, by which transport stream data are encrypted, recorded, and decrypted to be read.

A fifth object of the present invention is to provide a writing/reading system of HD stream, by which stable data transmission/reception is implemented using a hard disc as a buffering means for writing/reading.

A sixth object of the present invention is to provide a writing/reading system of HD stream, in which an interface with a DVD module is employed using a dual port memory, by which a delay time due to buffering is minimized, and by which real-time data transport is secured.

A seventh object of the present invention is to provide a writing/reading system of HD stream, in which encrypted downstream is transferred via a stream controller and by which contents protection for HD streams is enabled without separate encryption.

An eighth object of the present invention is to provide a writing/reading system of HD stream, by which mutual transmission/reception between DVD and PVR modules via fast data transport path for other medium formats (MP3, JPEG, etc.) can be provided as well as HD streams.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a writing/reading system of HD stream according to the present invention includes a receiving means for receiving an HD stream, an HDD storing the received HD stream, a DVD module for writing/reading the stored HD stream in/from a DVD medium, and a control means for controlling reception, storage, record, and reading of the HD stream.

In another aspect of the present invention, in a DVD recorder, a writing/reading system of HD stream includes a first module having an HDD to store an HD stream therein, the first module reading the HD stream, a second module receiving the HD stream stored in the HDD to write/read the received HD stream in/from a DVD medium, and an interface unit interfacing between the first and second modules.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a digital broadcast receiver according to a related art; and

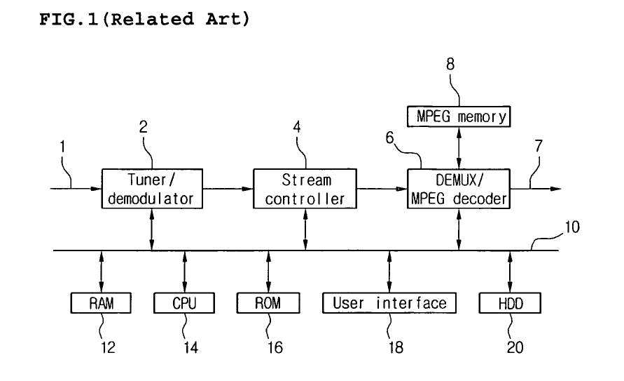

FIG. 2 is a block diagram of a writing/reading system of HD stream according to one embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

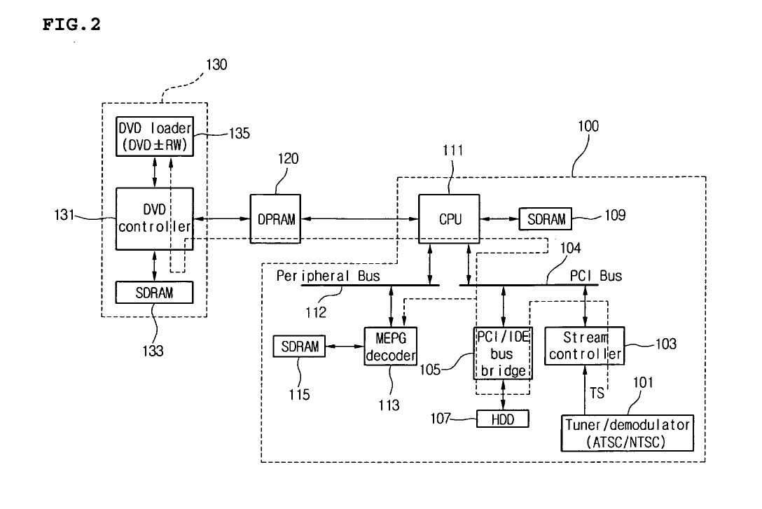

FIG. 2 is a block diagram of a writing/reading system of HD stream according to one embodiment of the present invention.

Referring to FIG. 2, a writing/reading system of HD stream according to one embodiment of the present invention includes a first module 100 having a PVR (personal video recorder) function, a second module 130 for writing/reading in/from a DVD medium, and an interface unit 120 connecting the first and second modules 100 and 130.

The first module 100 includes a tuner/demodulator 101 for channel selection and demodulation of a digital broadcast signal, a transport stream (TS) controller 103 transferring the demodulated transport stream as an encryption transport stream (ETS), a bus bridge unit 105 connected to a system bus, an HDD 107 for buffering the transport stream transferred via the bus bridge unit 105, a system memory 109 for temporarily storing the transport stream, a central processor unit 111 controlling the respective elements via the system bus, and an MPEG decoder 113 reading the transport stream, and a video memory 115 for temporary storage on stream play.

The second module 130 includes a DVD controller 131 for controlling a DVD loader 135 and a DVD memory 133 temporarily storing data wrote/read in/from the DVD medium by the DVD controller 131.

In this case, each of the system memory 109, the video memory 115, and the DVD memory 133 preferably includes an SDRAM (synchronous dynamic random access memory). The interface unit 120 preferably includes a DPRAM (dual-port RAM). The bus bridge unit 105 preferably includes a PCI/IDE Bus bridge. And, the system bus preferably includes a PCI (peripheral component interconnect) bus.

The above-configured writing/reading system of HD stream according to one embodiment of the present invention is explained with reference to the attached drawing as follows.

Referring to FIG. 2, the first and second modules 100 and 130 have the composite configuration. The first and second modules 100 and 130 are connected together by the interface unit 120 to transmit/receive data mutually. The composite device is operative as a DVD recorder having an HDD.

The first module 100 is a PVR module, the second module 130 is a DVD-RW (digital video or versatile disc-rewritable) module, and the interface unit 130 includes DPRAM for example.

The first module 100 includes the tuner/demodulator 101, the stream controller 103, the PCI/IDE bus bridge unit 105, the system memory 109, the CPU 111, the MPEG decoder 113, and the memory 115.

The tuner/demodulator 101 receives a broadcast signal via channel selection of HD digital broadcast signal and converts the received broadcast signal to digital transport stream (TS) to output.

The stream controller 103, which is connected to the system bus (PCI BUS), performs PID (packet ID) filtering of the demodulated transport stream under the control of the CPU 111 and encryption for copy prevention to accumulate the encrypted data at an internal buffer. In doing so, the stream controller 103 performs the encryption on the transport stream for record or storage or decryption for reading. The encryption and decryption functions can be optionally designated by a user.

The CPU 111 reads a predetermined quantity of stream data via the PCI (peripheral component interconnect) bus 104, stores the data in the system memory 109 temporarily, and reads the stored data again to store in the HDD 107 via the bus bridge unit 105 connected to the PCI bus 104.

Since the transport stream is encrypted by the stream controller 103, it can be provided as a contents protecting means for the HD stream without a separate encryption process. And, the stream data stored in the HDD 107 are stored as source data for the transport to the second module 130.

As the HD stream of terrestrial wave follows the transport stream (TS) format, buffering is needed to store the transport stream format in the DVD medium (e.g., DVD-RW) in direct. In this case, the HDD 107 is used as a buffering means. In case of being stored in the HDD 107, the transport stream format is stored in the formats of 4-byte timestamp and TS 188-byte encryption.

The HD stream stored in the HDD 107 enables real-time play via the MPEG decoder 113. The HD stream stored in the HDD 107 can be stored as an individual broadcast program within the capacity of the HDD 107. If one broadcast program is attempted to be stored in the HDD 107 that is out of capacity, a specific broadcast program that was previously stored is erased. If a user selects ‘DVD copy’ through a record list stored in the HDD, it is able to copy the corresponding broadcast program to the DVD medium.

Thus, a user attempts to write/read the HD stream, which is stored in the HDD 107, in/from the DVD medium.

For this, the CPU 111 transfers control data, which match with an interface state with the second module 130, to the DVD controller 131 of the second module 130 to record the HD stream in the DVD medium. Namely, the CPU 111 transfers the control data to provide an enabled state of data transfer.

Subsequently, the CPU 111 temporarily stores the stream data stored in the HDD 107 and then hands a control authority over to the DVD controller 131 of the second module 130. In doing so, the DVD controller 131 of the second module 130 reads the stream data stored in the system memory 109 of the first module 100 via the interface unit 120 and then stores the read data in the DVD memory 133 of the second module 130.

The DVD controller 131 of the second module 130 record the stream data stored in the DVD memory 133 by a predetermined speed in the DVD medium using the DVD loader (DVD±RW) 135. In this case, the data recorded in the DVD medium are the encrypted stream data of which copy is prevented.

In case of recording the HD stream in the DVD medium, information of the program is stored together. Since there exists a copy state flag of the program, it is able to put in the information of ‘Copy Never’, ‘Copy Once’ and the like.

Thus, as the CPU 111 and the DVD controller 131 transfers the HD stream to the second module 130 by real rime, the DVD controller 131 stores the HD stream in the DVD medium.

In the DVD medium, initial reading information of the HD stream is recorded together. The DVD medium is divided into record information, reading information, and data areas of the HD stream. A title, language, time, file size and the like of the HD stream are recorded in the record information area. And, reading address, equipment information and the like are included in the reading information area.

The interface unit 130 connecting the first and second modules 100 and 130 together includes a DPRAM. The DPRAM minimizes a transport time of the data transferred between the first and second modules 100 and 130 via buffering and enables transmission/reception of real-time data.

For fast data transport between two processors (CPU, DVD controller), the interface unit 130 divides a dual port RAM area into two channels to use as a transport control channel and a data transport channel, respectively. Separate transport protocol data is not added in the data transport channel to increase data transport efficiency. Instead, size information by block unit is included to be transferred. And, the transport control channel transmits/receives data transport channel control information.

Thus, once a user selects a specific broadcast program and sets up a storage path to the DVD medium, the selected broadcast program stored in the HDD 107 is recorded in the DVD medium. Moreover, the broadcast program stored in the DVD medium can be read via the MPEG decoder.

Meanwhile, the HD stream stored in the DVD medium of the second module 130 is read in a reverse sequence of the above-explained one. Namely, the DVD controller 131 of the second module 130 reads the data from the DVD medium and temporarily stores the read data in the DVD memory 133. The DVD controller 131 hands the control authority over to the CPU 111 of the first module to store the data, which are stored in the DVD memory 133, in the system memory 109 and then stores the data in the HDD 107. The data are decrypted by the stream controller 103. And, the decrypted data are decoded by the MPEG decoder 113 to be read.

Thus, the DVD recorder having the hard disc records the transport stream data received from the broadcast receiving module such as a PVR module and the like in the disc medium of another module and reads the transport stream recorded in the disc medium to enable reading. And, the DVD recorder provides the means for transmitting/receiving the transport stream data at high speed between the PVR and DVD modules, thereby minimizing the delay time due to buffering and thereby securing real-time data transmission.

And, the DVD recorder provides the mutual transmission/reception between the DVD and PVR modules via fast data transport path for various media formats (MP3, JPEG, etc.) as well as the HD stream. Moreover, the DVD recorder can provide an option of selecting one of HD and SD streams in recording of the DVD medium.

The usable authority of the DPRAM as the interface unit connecting the PVR and DVD modules is given to the DPU 111 of the PVR module or the DVD controller 131 of the DVD-RW module according to whether the system is in reading or writing mode.

For instance, the received transport stream data is stored in the HDD 107, and simultaneously, can proceed to the MPEG decoder 113 in a mode enabling real-time play. In this mode, the encryption process of the stream controller is skipped.

The above-explained composite system specifies a format to store the HD stream in the DVD medium and performs recording and playback according to the specified format. For another instance, since the DVD formats used as the record format of the current DVD medium are DVD-video and DVD-VR, it is able to store the HD stream in the disc of the two formats.

As mentioned in the foregoing description, the writing/reading apparatus of HD stream according to the present invention records or reads the HD broadcast stream in/from the disc medium by real time, thereby overcoming the storage limit of the conventional DVD-RW and thereby implementing stable data transmission/reception through buffering using the hard disc drive.

And, the present invention enables fast data transmission/reception with the DVD-RW module using the DPRAM, thereby minimizing the delay time due to buffering and thereby securing real-time data transport.

It will be apparent to those skilled in the art that various modifications and variations can be made in the present invention. Thus, it is intended that the present invention covers the modifications and variations of this invention provided they come within the scope of the appended claims and their equivalents.

1. A writing/reading system of HD stream comprising:
a receiving means for receiving an HD stream;
an HDD storing the received HD stream;
a DVD module for writing/reading the stored HD stream in/from a DVD medium; and
a control means for controlling reception, storage, writing, and reading of the HD stream.

2. The writing/reading system of HD stream of claim 1, wherein the receiving means comprising:
a tuner/demodulator for selecting a channel of a HD digital broadcast signal and demodulating a transport stream; and
a stream controller controlling a path of the demodulated transport stream.

3. The writing/reading system of HD stream of claim 2, wherein the stream controller performs encryption and decryption of the HD stream.

4. The writing/reading system of HD stream of claim 1, further comprising a video decoder performing decoding to read the HD stream stored in the HDD.

5. The writing/reading system of HD stream of claim 1, wherein the control means and the DVD module are connected to an interface unit.

6. The writing/reading system of HD stream of claim 5, wherein the interface unit is a dual port memory.

7. The writing/reading system of HD stream of claim 1, the DVD module comprising:
a DVD controller controlling a writing and reading to the DVD medium by a control of the control means;
a temporary memory temporarily storing the HD stream; and
a disc loader for the writing and reading to the DVD medium of the HD stream.

8. The writing/reading system of HD stream of claim 1, wherein the DVD medium has a DVD-Video format.

9. The writing/reading system of HD stream of claim 1, wherein the DVD medium has a DVD-VR format.

10. The writing/reading system of HD stream of claim 1, wherein the HD stream recorded in the DVD medium is encrypted.

11. In a DVD recorder, an writing/reading system of HD stream comprising:
a first module having an HDD to store an HD stream therein, the first module reading the HD stream;
a second module receiving the HD stream stored in the HDD to write/read the received HD stream in/from a DVD medium; and
an interface unit interfacing between the first and second modules.

12. The writing/reading system of HD stream of claim 11, wherein the first and second modules perform real-time transmission/reception for the HD stream.

13. The writing/reading system of HD stream of claim 11, the first module comprising:
a tuner/demodulator for channel selection and demodulation of a digital broadcast signal;
a stream controller for storing the demodulated transport stream in an HDD;
a video decoder decoding for reading of the transport stream; and
a CPU controlling the respective elements via a system bus to input/output the HD stream and control data to/from the first module.

14. The writing/reading system of HD stream of claim 11, wherein the stream controller performs encryption and decryption of the transport stream.

15. The writing/reading system of HD stream of claim 11, the second module comprising:
a disc controller controlling record and reading of the HD stream inputted/outputted to/from the first module;
a memory temporarily storing the HD stream therein; and
a disc loader writing/reading the HD stream in/from the DVD medium.

16. The writing/reading system of HD stream of claim 11, wherein the interface unit comprises a dual port memory.

17. The writing/reading system of HD stream of claim 13, wherein the CPU has a control authority for the interface unit to record the HD stream in the DVD medium.

18. The writing/reading system of HD stream of claim 15, wherein the DVD controller has a control authority for the interface unit to read the HD stream from the DVD medium.

19. The writing/reading system of HD stream of claim 11, wherein the first module is a PVR module.
